(19) United States
(12) Patent Application Publication
(10) Pub. No.: US 2006/0039382 A1
(43) Pub. Date: Feb. 23, 2006

(54) Telecommunication network comprising an SDH/Sonet-subnet, where the GMPLS function is incorporated in a GMPLS software server

(75) Inventors: Per Flemming Hansen, Soborg (DK); Kim Gormsen, Vaerlose (DK)

Correspondence Address: KLEIN, O'NEILL & SINGH, 2 PARK PLAZA, SUITE 510, IRVINE, CA, 92614, US

(73) Assignee: TPACK A/S, Bellerup (DK)

(21) Appl. No.: 11/253,527

(22) Filed: Oct. 19, 2005

Related U.S. Application Data
(63) Continuation of application No. 10/791,374, filed on Mar. 1, 2004.
Application No. 10/791,374 is a continuation of application No. PCT/DK02/00573, filed on Sep. 3, 2002.

(30) Foreign Application Priority Data
Sep. 3, 2001 (DK) PA 2001 01293
Sep. 12, 2001 (DK) PA 2001 01327
Oct. 16, 2001 (DK) PA 2001 01522

(51) Int. Cl. H04L 12/56

(52) U.S. Cl. 370/395.51

(57) ABSTRACT

A telecommunications network comprises SDH/Sonet sub-network constituting a transport network and with SDH/Sonet Add/Drop multiplexers, DVDM multiplexers, where the GMPLS function for a SDH/Sonet sub-network is collected in one single GMPLS software reserver.

### CROSS-REFERENCE TO RELATED APPLICATION

This application is a Continuation of co-pending U.S. application Ser. No. 10/791,374, filed Mar. 2, 2004, which is a Continuation of International Application No. PCT/DK02/00573, filed Sep. 3, 2002. The disclosures of both of these prior-filed applications are incorporated herein by reference.

### FEDERALLY-SPONSORED RESEARCH OR DEVELOPMENT

Not Applicable

### BACKGROUND OF THE INVENTION

The invention relates in general to GMPLS, i.e. “General Multi-Protocol Label Swappies or Switching,” and more particularly to techniques for the introduction of GMPLS in the telecommunications transport network in connection with IP Services, especially within the SDH/Sonet network. (“SDH” is defined as “Synchronous Digital Hierarchy,” the underlying electronic transport protocol which is used today in the European part of the telecommunications infrastructure. “Sonet” is defined as “Synchronous Optical Network,” the underlying electronic transport protocol which is used today in the American part of the telecommunications infrastructure.)

GMPLS is today under standardization and will potentially be introduced in order to achieve a better exploitation of the installed telecommunications transportation network in connection with IP Service.

However, this introduction of GMPLS will necessitate an upgrading of the many existing installed SDH/Sonet Add/Drop multiplexers in a SDH/Sonet network—with the GMPLS topology and reservation software—so that the SDH/Sonet canal resources (VC paths etc.) can enter as visible dynamic allocatable resources in the EP service. Furthermore, these SDH/Sonet Add/drop multiplexers do not necessarily dispose of additional CPU force today to carry out such an upgrading, which will in this case demand a sort of hardware upgrading.

Relevant background techniques within this field are disclosed/described in the following publications: WO 0036871; WO 0171986; Orda, “Routing with end-to-end QoS Guarantees in Broadband Networks”; Chen et al., “Reliable Services in MLPS”; U.S. Pat. No. 6,262,989; EP 0 982 902; U.S. Pat. No. 6,215,791; Kweon et al, “Providing Deterministic Delay Guarantees in ATM Networks”; EP 0 969 621; EP 1 122 971; EP 1 087 576; EP 1 052 859; U.S. Pat. No. 6,154,444; EP 0 753 979; WO 0184272. In this connection reference is made to these references, like the content of these are hereby considered being part of the present specification.

For the purpose of this specification the term “ATM” will be understood to mean “Asynchronous Transfer Mode,” which is an electronic data protocol that is widespread in the Access net of the telecommunications infrastructure.

Another aspect of the invention relates to a representation of an arbitrarily large optical transport network (hereinafter referred to as “OTN”) to the surroundings with a virtual network (hereinafter referred to as “VN”), where the VN represents the OTN to the surroundings as a simpler network topology which hides the inner topology of the OTN, so that it is not visible in the VN. The VN conserves the same external connection points as to the OTN.

A further aspect of the invention relates to a system for the scheduling of data traffic in the communications systems. The system can partly be used in cell based systems (e.g. ATM), partly in package based systems (IP, MPLS/GMPLS, frame-relay etc.). The system comprises a queue system, a control unit, a delay unit and a priority unit. Numerous different methods exist for scheduling data traffic. The object of these is to control the order, whereby the data cells or data packages in a digital communications system are sent to a data channel, and thereby fix an order of priority between different data flows or control data profiles for the individual data flows.

Examples of mechanisms or techniques are:
Generalized Processor Sharing (GPS)
Weighted fair queuing (WFQ)
Weighted round robin (WRR)
   where virtual time is operated with. These mechanisms can give a relative order of priority of a number of data flows in relation to each other. A data flow can, for instance, be given double amount of bandwidth of another data flow. Thus, the regulation of the individual flows takes place relatively compared to the rest of the data flows. In the following such a unit will be mentioned a priority unit, an order of priority being mainly given between a number of data flows.

Other mechanisms operate with absolute time and are capable of carrying out an absolute control of those bandwidths that the individual data flows are given. By way of example, one data flow is given 2 Mbps and another data flow is given 3 Mbps. The regulation of the individual data flows thus takes place on the basis of absolute criteria, which are independent of the rest of the data flows. In the following, such a unit is called a delay unit. A delay is mainly being carried out between the individual cells or packages.

There will often be a wish of simultaneously aiming at both absolute criteria and relative criteria. It can be, for instance, that data flow A must have two times as large a bandwidth as data flow B; but that data flow A can at a maximum be transmitted with 2 Mbps, and data flow B can at a maximum be transmitted with 3 Mbps. At the same time, requirements can be made as to a minimum of bandwidth, data flow A thus having a guaranteed bandwidth of 1 Mbps, while data flow B has no guaranteed bandwidth.

A typical utilization of such a system is for ATM ABR service, where a fair distribution of the bandwidth between a number of data flows is wanted, but where the flow control mechanism (controlled through RM cells in the opposite direction of the data traffic) sets a limit to the bandwidth of the individual data flows.

### SUMMARY OF THE INVENTION

The invention relates to a system which makes it possible at the same time to control data flows according to both absolute and relative criteria.

At the basis of the present invention lies an object of enabling the introduction of GMPLS without the necessity of upgrading all of the distributed SDH/Sonet Add/Drop multiplexers with the necessary and relatively complex GMPLS software.

This object is achieved with the solution characteristic of the invention which is using a central approach, in which a GMPLS Proxy agent is used to run the GMPLS software for an entire SDH/Sonet sub-network and using existing management center software for the dynamic set up of SDH/Sonet paths.

Thus, it becomes technically easier to introduce GMPLS, i.e. it demands less upgrading and fewer technical resources.

The background of the invention and the advantage of the technical solution characteristic of the invention will appear from the following description.

The invention specifically relates to the method of calculation in which one can, dynamically, on the basis of knowledge on possible bandwidth in an OTN between external connection points, convert this to available bandwidth in a VN.

This is of importance in connection with the integration of IP/MPLS network as well as OTN, according to which one in the future wants to be able to signal and set up an IP/MPLS connection in through the OTN without the IP/MPLS network knowing the inner topology of the OTN, but where only the external connection points with the OTN are published in the IP/MPLS router topology.

### BRIEF DESCRIPTION OF THE DRAWINGS

FIG. 1 schematically illustrates an embodiment of a network including Central Management Center, GMPLS software and GMPLS software server.

FIG. 2 schematically illustrates an access network based on a SDH/SONET transport network built up of ring structures.

FIG. 3 schematically illustrates different physical components that enter into the telecommunications network.

FIG. 4 schematically illustrates the IP routers being mutually connected through fixed switched logical connections over the transport network.

FIG. 5 schematically illustrates an IP router.

FIG. 6 schematically illustrates IP packages passing through a number of IP routers.

FIG. 7 schematically illustrates the access of the same user to his/her wanted WEB host.

FIG. 8 schematically shows the different protocol layers for the connection from User 1 to WEB Host 2.

FIG. 9 schematically illustrates how a few stretches of the IP infra structure may be especially overloaded.

FIG. 10 schematically illustrates how to consider the overloading of each link using MPLS.

FIG. 11 schematically illustrates the components that an IP package must go through in the physical network.

FIG. 12 schematically illustrates the GMPLS permitting a selection of a more direct path.

FIG. 13 schematically illustrates the physical IP/GMPLS view.

FIG. 14 schematically illustrates an MPLS package switch in which different MPLS tunnels are packed in an interleaved relationship between each other.

FIG. 15 schematically illustrates how add/drop multiplexers are not based on package transport but are based on time multiplexing of logic channels, where the individual channels are fixed temporally and BYTE interleaved between each other.

FIG. 16 schematically illustrates a component.

FIG. 17 schematically illustrates a “GMPLS Proxy Agent.”

FIG. 18 schematically illustrates management center software.

FIG. 19 schematically illustrates an occasionally selected OTN.

FIG. 20 schematically illustrates two different examples of VN hiding the topology of the OTN illustrated in FIG. 19.

FIG. 21 schematically illustrates an example of a distributed data base.

FIG. 22 schematically illustrates the distributed data base from FIG. 21.

FIG. 23 schematically illustrates an example of a physical IP/MPLS net work comprising 6 IP/MPLS routers.

FIG. 24 schematically illustrates an example of a Virtual Network representing an optical network having 4 external connections.

FIG. 25 schematically illustrates mapping of free band width.

FIG. 26 schematically shows the system for scheduling data traffic according to the present invention.

FIG. 27 schematically shows the algorithm for the distribution of data traffic between delay unit and priority unit.

FIG. 28 schematically shows a possible implementation of the delay unit.

FIG. 29 schematically shows a possible implementation of the priority unit.

### DETAILED DESCRIPTION OF THE INVENTION

The technical solution itself lying at the basis of the invention is illustrated in FIG. 1. By way of introduction, a presentation of a general introduction to the basic technologies which are of an importance to the invention is given.

Firstly, the structure of the telecommunications net and the technologies which are relevant is introduced. Subsequently, the IP problem presentation that has led to the international standardization world's introduction of the next generations IP technologies, named MPLS and GMPLS, is described.

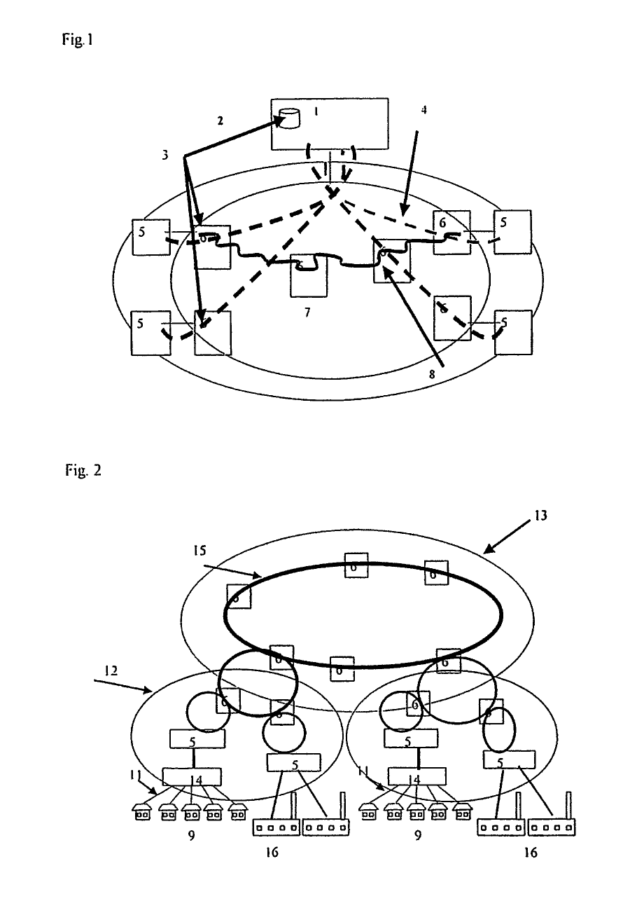

The telecommunications net, as shown in FIG. 2, can physically be divided into three parts:
The connections to the home users and the companies.
The Access network for the concentration of the user connections.
The trunk network which forms the basis of the world wide telecommunications net.

The Access net is the part of the telecommunications infrastructure connecting the private companies and the users to the telecommunications infrastructure.

The trunk network is the backbone in the telecommunications network, i.e., the part of the telecommunications structure which connects territories, cities and countries.

In the past, the home users typically connected themselves to the telecommunications network through relatively slow telephone-based modems. Thereafter, the ISDN was introduced with connections of up to 128 kbit/s, and today the ADSL and cable TV network is at the point of lifting this level at 2 Mbit/s; and 512 kbit/s, respectively. (ADSL, standing for “Asymmetric Digital Subscriber Line,” is technology using the existing telephone lines out to the private homes.)

Home users are mainly connected to the Internet to have World Wide Web access, but home-based working places are also commonly widespread, where the Internet serves as an extension of the companies' local network (Intranet).

For years, the market has focused on the development of new technologies which can offer new services and improve the bandwidth for the home users by using existing telephone connections as well as cable TV network on the last stretch. The background for this is that the establishing of new cables to the home users involves considerable investments, especially for the burial of the cable.

Similarly, the companies connected themselves a few years ago through a fixed low-end line, whereby the level was increased to 2 Mbit/s, and the Ethernet technology is on the way with 10 Mbit/s, 100 Mbit/s and 1 Gigabit/s per connection.

Ethernet is the technology that is typically used within a company's local area network (LAN), which is typically used in a company to connect its personal computers and servers. This technology is now seriously on its way into the Access part of the telecommunications network, being a very economical technology which is easier to integrate into the local network of the companies.

The use of the Ethernet technology in the Access network will potentially demand the establishing of new fiber-based connections. Investments in cable replacements for companies are paying more compared with the home users, the market of Intranet traffic being approximately 4.5 times as large as the market of Internet traffic.

The Access network is, as shown in FIG. 2, based on a SDH/SONET transport network built up of ring structures. This network is basically optimized toward the transport of traditional telephone traffic. In order to be able to offer data services, an IP structure consisting of IP routers, ATM switches and Frame Relay switches has subsequently been built on to the transport network.

In the future, the focus will change from an optimization of traditional telephony to the optimizing of IP traffic. MPLS (Multi-Protocol Label Switching) and GMPLS are IP technologies, which integrate the data technologies with the transport network in a considerably better and more cost-optimal way. The next generation's protocol is a further development of the IP which has the necessary scalings quality for the Internet in order to meet the new requirements of speed and minimum delays for new IP services—among others Internet telephony based on IP.

The trunk network constitutes the backbone of the telecommunications network. It is mainly built up of strong backbone SDH/SONET rings. In modern times, this has been combined with DWDM (Dense Wave Division Multiplexing, a technology for sending, via several frequencies or colors in one fiber, thereby increasing the entire capacity per fiber) equipment which makes it possible to send many SDH/SONET signals in through the one and same fiber, thereby multiply the bandwidth capacity per fiber stretch. In the future, purely optical switches will also be introduced in the trunk network.

The IP network is today built up as a global world-wide IP service which is established in the form of an IP router infrastructure which is connected through the telecommunications transport network itself.

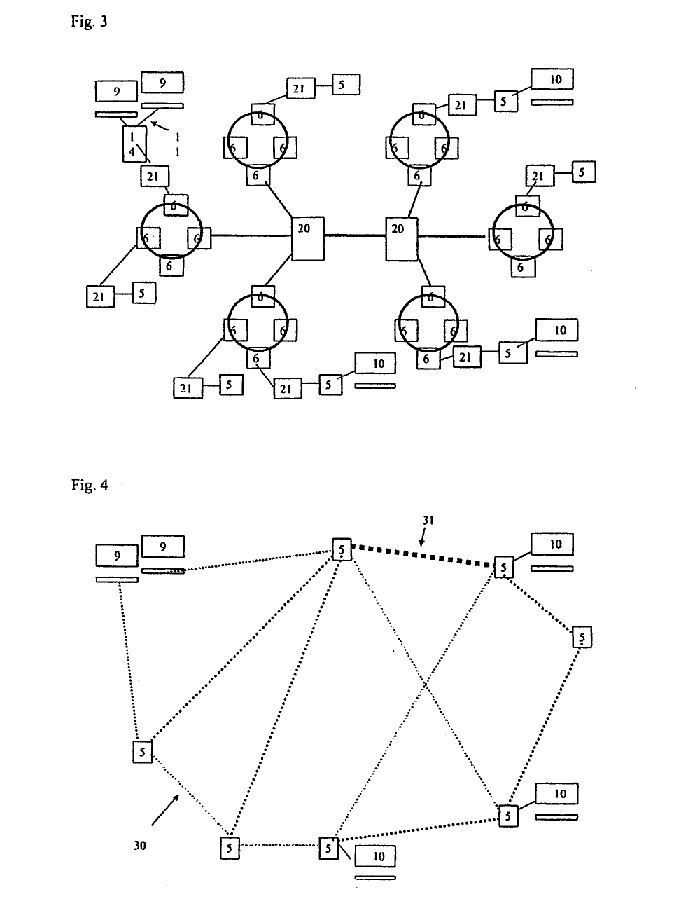

FIG. 3 shows the different physical components which enter into the telecommunications network, and wherein it is illustratively divided in the transport network itself, and on to this a data service that includes IP.

The global IP service is illustrated as a number of IP routers which are typically connected through a number of ATM switches 21 on top of the existing fiber-based and world wide transport network which consists of SDH/SONET multiplexers 5, DWDM multiplexers 20, and optical switches.

The users and the applications who wish to connect themselves to the Internet through ISP's (Internet Service Providers) can be connected through several different types of connections—but are in FIG. 3 shown either as ADSL connections, that are connected through a ADSL DSLAM 14, or directly through an Ethernet connection. It is especially these technologies which are expected to be predominant in future. (Ethernet is the most widespread electronic transport protocol, which within a company's local network, is used to connect PC's, servers etc.)

The IP routers are mutually connected through fixed switched logical connections over the transport network. FIG. 4 shows this, where the components from the transport network itself are removed. The fixed switched logical links are illustrated with dotted lines 31. These are links of a relatively large bandwidth, typically 155 Mbit/s or more, which are to be dimensioned to ‘busy hour’ load. Attention is drawn to a single connection 30, which has a larger bandwidth than the other ones (see below).

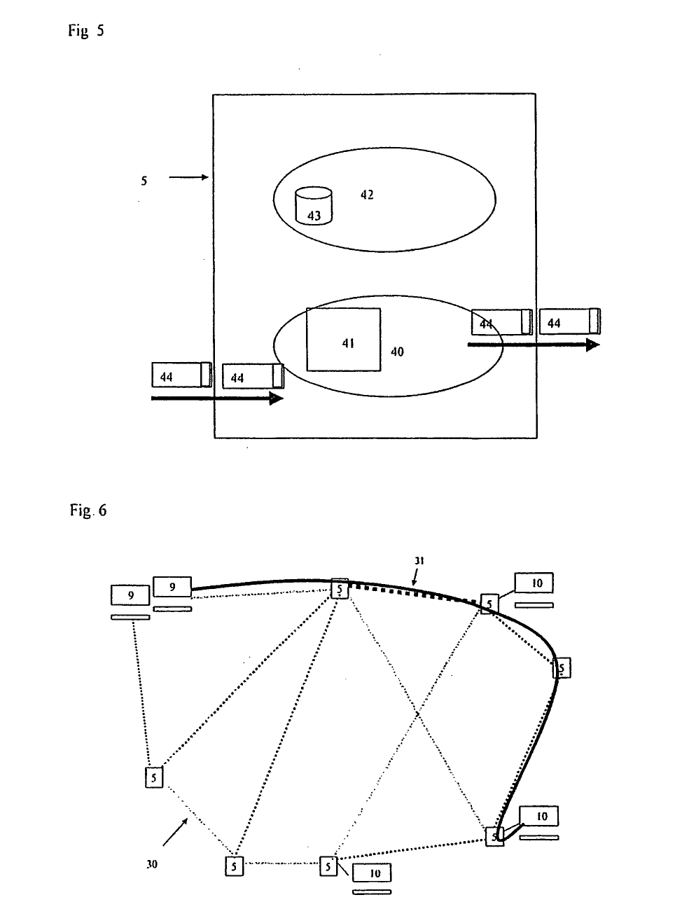

The forwarding of IP-packages is taken care of by IP routers. Figuratively speaking, an IP router (shown in FIG. 5) can be compared to a post office. A post office sorts and forwards letters on the basis of the addresses on the envelopes. An IP router sorts and forwards data packages on the basis of an IP header in the front of the package which contains the address of the sender of the IP and the address of the addressee of the IP.

If a post office is overloaded, it breaks down (which is a known Christmas phenomenon where everybody sends a lot of letters). This issue can be compared with the problems which exist in the IP net of today, only on a much larger scale and with daily overloading situations.

Furthermore, post offices have an express delivery letter service so that particularly important letters also reach their destination in periods of overloading. The traditional IP routers only have a similar possibility to a very small extent, and this facility is to be much extended during the coming years.

As illustrated in FIG. 5, an IP router logically consists of a set of software which controls the network topology (the structure), as well as hardware forwarding IP packages based on address references in tables calculated by the software.

The software in every IP router exchanges continuous topology information with one another through a standardized IP topology protocol, where OSPF (“Open Shortest Path First”) is currently used. By means of OSPF, every IP router obtains an updated knowledge of the entire network's actual structure—the image of this network is collected in a distributed database in every IP router. OSPF is one of the large software IP routing protocols that is used in IP routers to distribute knowledge about the topology in an IP network.

The database contains information on all the IP routers, as well as information on the links which connect them mutually. All links are configured with a distance value that makes it possible to calculate the shortest distance to every known IP address of the node. From the database, each IP router independently calculates a local address table, where all of the IP addresses known within the network can be viewed, and, as a result, tell how an IP package can be forwarded to the next “hop” on its way to a given IP receiver.

When a user logs on to a Web page on the Internet from his/her own PC, a lot of packages are sent between the user's PC and the Web host machine, which is typically placed somewhere in the world. All the IP packages pass through a number of IP routers on their way, as is illustrated in FIG. 6 by means of the heavy black line A. As an example of this, it can be mentioned that to go from one home PC to the home page of Intel.com, a large number, such as 14 or more “hops” must be passed.

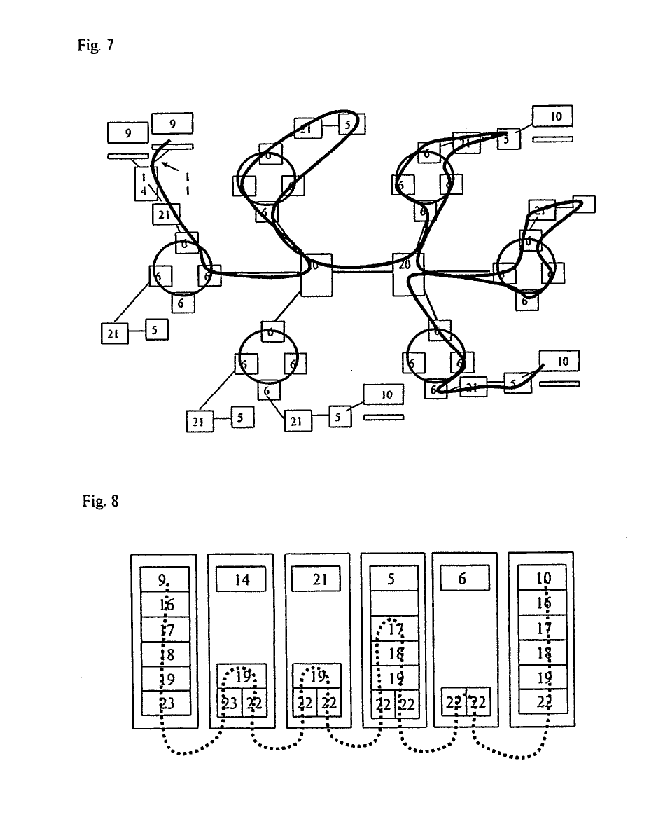

This logical way is only one part of the explanation—the physical way complicates the story substantially. FIG. 7 shows the access of the same user to his/her wanted Web host, but now both the transport components and the data service layer are shown. This is to illustrate that there are a many components that the IP packages are to go through on their way.

The complexity of the IP is illustrated in FIG. 8, which shows the different protocol layers for the connection from User 1 to Web Host 2. (Owing to consideration of space, a single ATM switch 21, Add/Drop multiplexer 6, and IP router 5 are shown.)

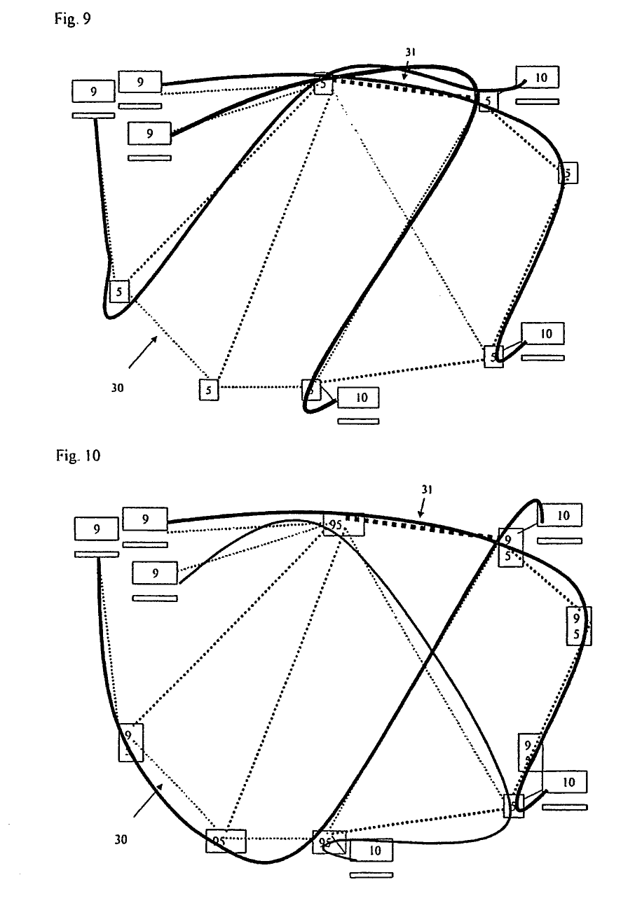

The IP protocols are arranged in such a way that they always attempt to send an IP package by the shortest way to the final receiver. This takes place without consideration to the possible overloading of the individual IP router links. Thus, there is a tendency, as shown in FIG. 9, of a few stretches of the IP infrastructure being especially overloaded, whereas other stretches are in general unused.

This gives a poor general router link exploitation, which is inappropriate. Apart from that, there are great problems of overloading of the IP network, which has become a yet bigger problem due to the many new IP services, in the form of voice and video applications etc., making demands as to maximum delay and demanding the availability of a minimum bandwidth. The existing IP protocols cannot solve this issue.

MPLS is the new IP package technology described in the above mentioned two WO publications and which has been developed within the international standardization over the last couple of years with a view to solving the basic problems within the IP infrastructure concerning scaling, order of priority, queue formation and delays as a consequence of the growing offer of different kinds of IP services (telephony, data, video). As shown in FIG. 10, it is possible with MPLS to consider the overloading of each link.

According to a White Paper from Marconi, some service providers have expressed that they lose up to 40% of their network capacity when using traditional IP routing, compared to what they can achieve with MPLS.

Furthermore, the traditional IP routing protocols have, in overloading situations, only to a small extent the possibility of giving priority between different types of IP packages. All IP packages will experience delays, regardless of the type (IP telephony, mission critical data transport or just ordinary Web browsing). Thereby, the network can not be used for, e.g., a global IP telephony service.

In order to be able to give priority to each IP package from a point of view of traffic type, the so-called IP diff. service function has been developed, which IP diff. service function can give priority to and classify IP packages. When combining MPLS with IP diff. service, the infrastructure is utilized in a more appropriate way, partly by being able to send high priority traffic by non-overloaded stretches, and partly by being able to giving a lower priority to less important packages. (“IP diff. service” is an expansion to the IP protocol so that several types of traffic with different time requirements, such as data, telephony, and video, can be sent over the same line, i.e., where different priorities can be given to the individual packages.)

Technically, the MPLS technology solves the above problems by being able to combine traditional IP routing with a new way of IP transmission, in which especially classified IP packages are sent through the net through dynamically allocated logic IP tunnels and in which the individual logic IP tunnel guarantees to observe a more precisely specified package traffic contract regarding delay, bandwidth, error rate etc.

This is achieved by reserving/allocating the necessary network resources already at the layout of the logic IP tunnels. An IP tunnel will be refused at the layout if the necessary resources are not available. These IP tunnels can run transversely to a network with numerous technologies, including Ethernet, ATM, and Frame Relay (an older electronic data protocol that is widespread within the Access net of the telecommunications structure).

When an IP package is sent into an IP tunnel, it is provided with a label in the front of the package. Within the interior of the MPLS network, the package will therefore only be switched and treated on the basis of this label which is simpler, as an analysis of the entire header of the IP package is not necessary to determine which tunnel and which class the package belongs to. At the end of the IP tunnel, the label is removed from the package, after which the package is forwarded as an ordinary IP package in a traditional IP network.

Apart from the IP, Ethernet packages can be sent through a MPLS tunnel. This feature is, among other things, suitable for establishing logic Ethernet connections between a company's departments.

Although the above-mentioned may be seen as small modifications, it demands, however, considerable fundamental changes in the underlying IP technology, which, in turn, demands new hardware and new ASICs (Application Specific Integrated Circuits) in the IP router systems.

Moreover, software has to be updated, wherein the software-heavy IP routing's topology protocol has been extended. In the standardization, the OSPF is updated to “OSPF-TE,” which enables that the distributed database previously mentioned can now also keep control with available bandwidth on each and every link in the IP network. Furthermore, a new protocol called “RSVP-TE” is used for setting up the MPLS tunnels through the net and reserving the wanted bandwidth. (“RSVP” is defined as Resource Reservation Protocol, a software protocol used in the IP routers to reserve bandwidth, etc.)

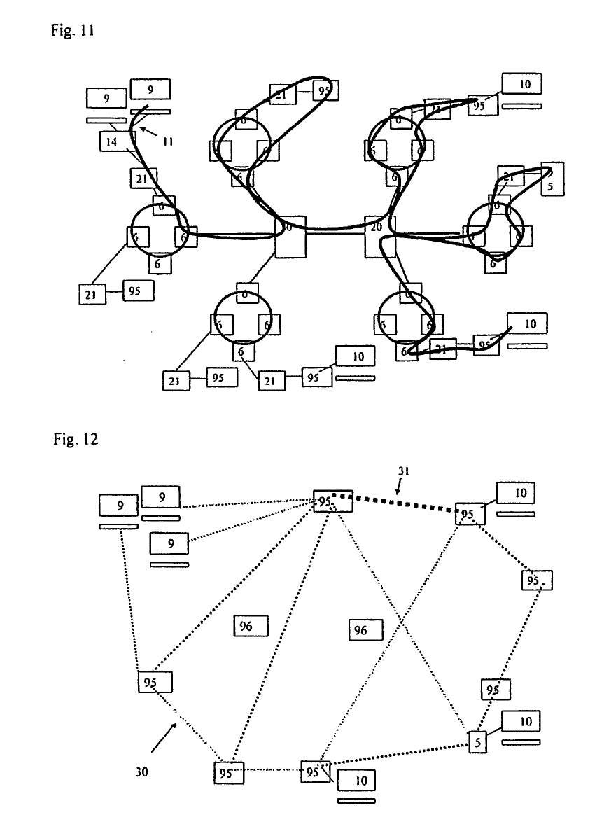

As shown in FIG. 11, there are still a lot of components that an IP package must go through in the physical network, even after the introduction of MPLS. In the example, they are the same components as for traditional IP.

Especially regarding the type of MPLS tunnels which have a constant bandwidth, it is not optimal to have to go through the IP/MPLS routers' package hops with attendant delay as well as delay variation.

This is to be seen in connection with the optical transport network (SDH/SONET etc.) being exactly created to be optimal regarding delay and delay variation. Furthermore, in the event of cable breaks, it is difficult within IP/MPLS to achieve protection switch times of a maximum of 50 ms that are known from the optical transport network.

The GMPLS (Generalized Multi-Protocol Label Switching) that is currently under standardization will enable the withdrawal of the transport network's components in the IP/MPLS dynamic, which will enable a visualization at IP level of systems such as SDH/SONET Add/Drop multiplexers, DWDM equipment as well as Optical switches. GMPLS is a further development of MPLS so it also can be used in ADH/Sonet based networks.

Thereby the IP tunnels can be combined with time-multiplexed SDH/SONET tunnels, as well as optical wavelength/frequency multiplexed tunnels.

As shown in FIG. 12, the GMPLS permits a selection of a more direct path, because many of the fixed switched logic IP/MPLS router links can be substituted by shared, shorter and thus cheaper fixed logic links between the GMPLS components.

The more fine-meshed the ‘spider web’ can be made between the GMPLS components, the more effective and economically attractive a network is achieved as a marketer of services. As a technology, the GMPLS opens up for the possibility for this at a considerably cheaper price, as the transport part already constitutes a very large part of the network. For the purpose of this specification, the “transport part” of the telecommunications infrastructure is considered the basic telecommunications network connecting all cities and areas in the world, that is used to transport telephony and data.

In order for the transport component to be GMPLS enabled, i.e., to enter into the IP/MPLS topology, it is necessary that it be provided with GMPLS software (OSPF-TE and RSVP-TE).

It is also alternatively possible to let a shared management system participate with the GMPLS software as a proxy for an entire transport network. This is practical as the transport network is currently centrally controlled. This further enables a faster introduction of the GMPLS into the transport network.

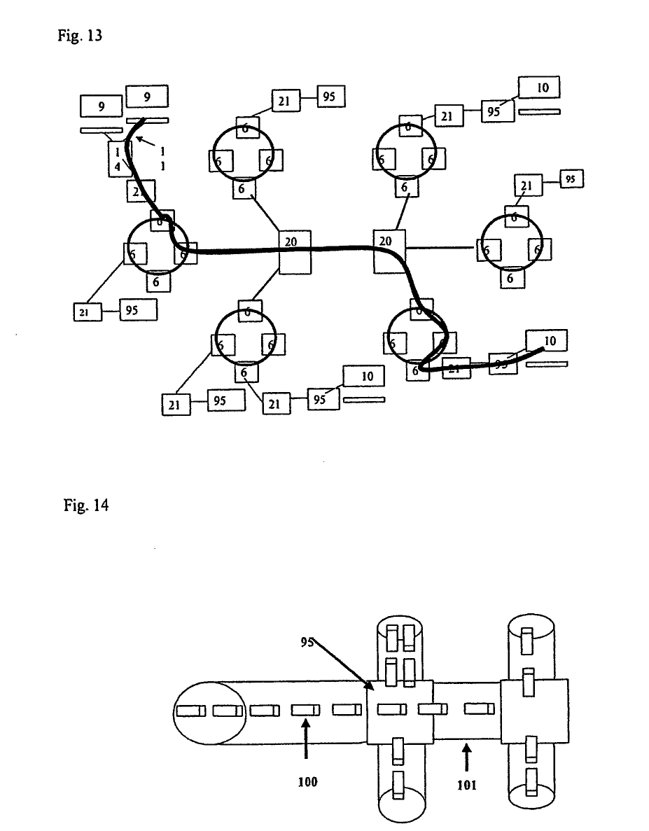

As shown in FIG. 13 with the physical IP/GMPLS, it is not necessary that all transport components are withdrawn as GMPLS enabled which enables a gradual updating to GMPLS.

To achieve an optimal utilization of the GMPLS, a component at the transition from MPLS to/from GMPLS is required as to the hardware, which is to be able to convert between the two different technologies.

FIG. 14 shows an MPLS package switch in which different MPLS tunnels are packed in an interleaved relationship between each other.

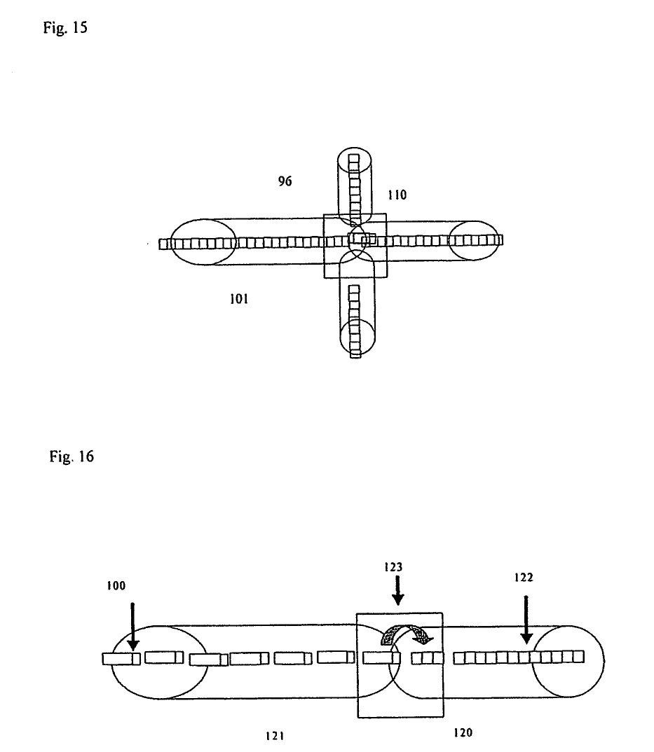

Add/drop multiplexers are not based on package transport but are based on time multiplexing of logic channels, where the individual channels are fixed temporally and BYTE-interleaved between each other. This is illustrated in FIG. 15.

In order for a MPLS based package technology to be able to function together with a GMPLS time multiplexed technology, it will be necessary to establish a functionality which can convert between these two technologies, cf. the illustration in FIG. 16. As shown in FIG. 16, a component that can redistribute the package channels to the time multiplexed byte channels is needed.

This is further complicated by the fact that within the SDH/SONET a virtual concatenation concept has just been introduced, in which a number of time multiplexed byte channels can be aggregated to a single channel, hereby rendering it possible to obtain several steps in possible bandwidth per channel. However, this requires that equalization buffers are implemented on the reception side, as the different aggregated sub-channels can run through different paths throughout the net due to the protection switching mechanisms in the transport network and therefore do not delay each BYTE similarly.

As the transport of IP traffic is growing with 100% per year, it is natural that the transport network is optimized as regards the IP service. Concurrently with the IP being on its way to be the actual transport service of the future, it is naturally in the interest of the suppliers of transport equipment to optimize their equipment for the transport of IP traffic, so that the IP router suppliers do not take over and replace the entire transport service. Furthermore, it is in the interest of the operators that the very considerable investments which have been made in transport equipment are utilized as optimally as possible for the IP traffic of the future. It would be a very expensive solution if the entire transport network at a standardization and a development level had to be replaced with other completely new and pure IP technologies, which in any event should have many of the current basis characteristics of the transport network.

With the GMPLS, a far better utilization of the existing transport network's resources is achieved in connection with IP, which from an economical point of view is a much more essential argument for the primary target group of the GMPLS technology, i.e. the suppliers of the transport services and the data service services (the telecommunication operators and the ISP's).

With the introduction of the GMPLS, a possibility of a large product differentiation is obtained, in which all the interested parties of the market, both the data/router interested parties and the transport interested parties, can optimize the products regarding the optimal supplying of the IP services of the future, where the data service advantages can be combined with the transport service advantages.

There are, in particular, many possibilities in being able to offer data service add-ons to already-installed transport network products which will cohere in a global IP/MPLS/GMPLS service. The GMPLS enables, for example, that new services such as ‘bandwidth on demand’ will be introduced, in which a final user/company itself can increase the bandwidth of the VPN (Virtual Private Network: a company's virtual IP network through the public infrastructure) during only seconds instead of, as today, where it can take up to a month to change this. The VPN is “virtual,” because all the companies' VPNs are based on the same public IP infrastructure without traffic being intermingled between the firms.

This concept can be illustrated as follows: While the MPLS as a technology focuses on the data service—and thereby on the router suppliers—the GMPLS will, as a technology, withdraw and thereby focus on the suppliers of telecommunications transport equipment.

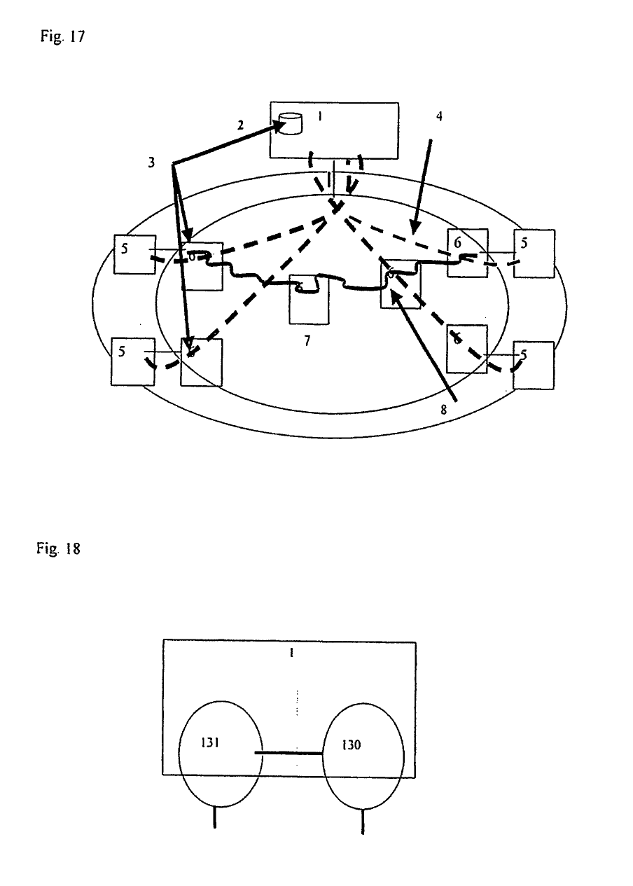

As shown in FIG. 17, the “GMPLS Proxy Agent” can be used in connection with the introduction of the GMPLS in the telecommunications transport network in connection with the IP service, especially in the SDH/Sonet network.

As mentioned previously, the GMPLS will require an upgrading of the many already installed SDH/Sonet Add/Drop multiplexers in a SDH/Sonet network—with GMPLS topology and reservations software—so that the SDH/Sonet channel resources (VC paths etc.) can enter as visual dynamic allocatable resources in the IP service. In addition, these SDH/Sonet Add/Drop multiplexers do not necessarily dispose of the additional CPU power to carry out such an upgrading, which in this case will demand a sort of hardware upgrading. VC-VC3-VC4-VC4c are Different types of logic channels in SDH/Sonet.

Instead, the “GMPLS Proxy Agent” enables the introduction of GMPLS without necessitating the upgrading of all of the distributed SDH/Sonet Add/Drop multiplexers with the necessary and relatively complex GMPLS software. The reason for this is that a central approach is used, in which the GMPLS Proxy Agent can take care of the running of the GMPLS software for an entire SDH/Sonet sub-network and uses existing management center software for the dynamical setting up of SDH/Sonet paths. This will ease the introduction of the GMPLS considerably.

Today, the SDH/Sonet sub-network is typically controlled and configured from a central management center. Paths (VC paths) through the SDH/Sonet sub-network are configured relatively statically, typically by an operator/person clicking on a window on a screen at the central management center. The operator/person marks from where to where a VC path is to be created, after which the management communications software communicates with the involved SDH/Sonet Add/Drop multiplexers.

In the “GMPLS Proxy Agent” this existing management software is utilized, thus not changing the way the individual SDH/Sonet Add/Drop multiplexer is configured regarding the layout of the VC paths.

In the “GMPLS Proxy Agent” a GMPLS software server is introduced simultaneously for an entire SDH/Sonet network. GMPLS topology and reservations packages are collected from the edge of the SDH/SONET network and forwarded from here to the central GMPLS software server. Thus, this GMPLS software talks with the IP surroundings on behalf of the SDH/Sonet network. When starting up a small number (not necessarily all) of SDH/Sonet resources are dynamically at the disposal of the IP service. Hereafter, it is the GMPLS software's task is to distribute knowledge about these resources out into the IP/MPLS network. When the IP/MPLS service at a moment through reservation protocols asks to reserve a GMPLS tunnel in through the SDH/Sonet network, the GMPLS software receives these requests and asks the existing management center software for help to set up a wanted SDH/Sonet tunnel—after which this, through its existing management protocols, communicates down into the relevant SDH/Sonet Add/drop multiplexers so that the SDH/Sonet tunnel is set up.

All in all this means that within the “GMPLS Proxy Agent,” the installation of some MPLS/GMPLS enabler cards on the edge of the SDH/Sonet network has to be carried out—e.g. where the IP/MPLS routers are connected to the SDH/Sonet network. These enabler cards forward the GMPLS topology and reservations packages up to the central GMPLS software server. The “GMPLS Proxy Agent” therefore also demands the installation of a GMPLS software server which can partly communicate with these enabler cards, but also with the existing management center software—which maybe has to be upgraded in order to offer this.

The “GMPLS Proxy Agent” covers two solutions:
1) where the GMPLS software is physically included on the central management center software, i.e. translates it into the management center; and
2) where the GMPLS software is physically separated on its own management server which then, e.g., through a TCP connection, communicates with the existing management center.

In FIG. 18, the management center software is illustrated very simply, which in this case is extended with the GMPLS function. FIG. 18 shows typical protocols used in connection with GMPLS: ISIS-TE, RSVP-TE, OSPF-TE, and possibly BGP4.

In accordance with the invention, it is not considered which specific protocols have to be used as reservation protocol and topology protocol in connection with GMPLS. Instead, the invention covers all these plus coming protocols, the main object of the invention being to cover the features of collecting the GMPLS software function centrally (possibly in a few pieces to cover redundancy) for a whole SDH/Sonet sub-network, instead of distributing the GMPLS software out into all the SDH/Sonet Add/Drop multiplexers.

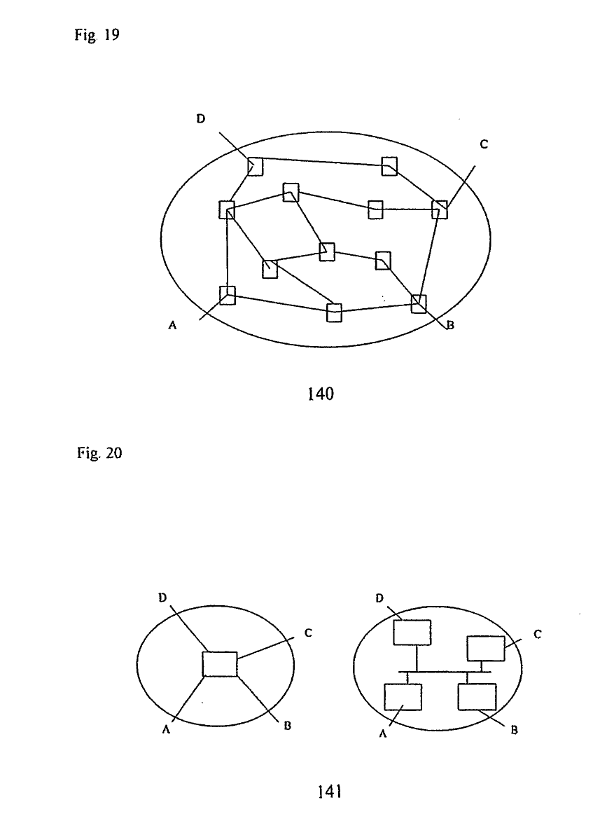

FIG. 19 shows an occasionally selected OTN, while FIG. 20 shows two different examples of a VN (virtual network) hiding the topology of the above-mentioned OTN, but keeping the same external connection points. The last requirement on the best possible preserving of potential bandwidth between two arbitrarily selected connection points, e.g. A-B, is not shown and will be described later.

In accordance with the invention, it is essential to understand the significance of being able to represent an optical transport network (OTN) as a simpler VN in an IP/MPLS network while simultaneously preserving the overview in the best way in a VN on potentially available bandwidth between two arbitrary external connection points to an OTN. This is why the functioning of an IP/MPLS router network is briefly to be explained regarding the calculation and the setting up of a connection through an IP/MPLS network.

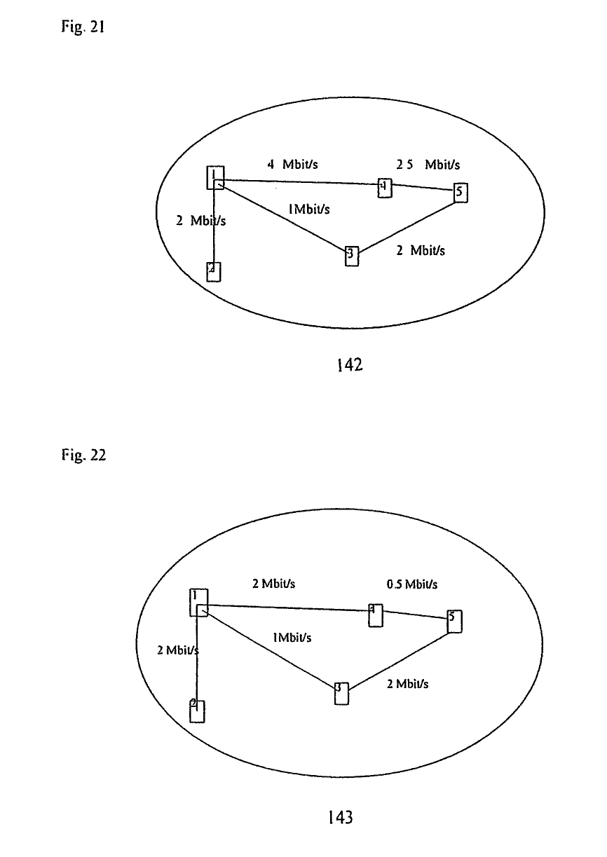

An IP/MPLS network consists of a number of IP/MPLS routers that are connected through a number of links. In this IP/MPLS network, a dynamic database is maintained, which database controls the amount of available bandwidth per link in the IP/MPLS network. This database is present in each of the IP/MPLS routers, vide FIG. 21.

Suppose that a reservation/establishing of a connection of 2 Mbit/s in FIG. 21 is wanted between IP/MPLS router 1 and 5. After establishing/signalling such a connection, the distributed IP/MPLS database will change so that there are 2 Mbit/s less available bandwidth between router 1 and 5, vide FIG. 22.

In connection with the development of the optical transport network consisting of optical switches and SDH/Sonet Add/Drop multiplexers and development of the amount of traffic of IP/MPLS, a wish of enabling the IP/MPLS network to dynamically being able to set up connections through the optical network in the standardization organizations exists, without the inner topology of an OTN being published to the IP/MPLS routers. However, it is necessary that the IP/MPLS routers know the external connection points to the OTN, so that a connection can dynamically be signalled through the OTN between two such points. A protocol for this purpose is among other things under standardization within the OIF (Optical Internet Forum) and in IETF (Internet Engineering Task Force, the organization standardizing the Internet protocols, among others IP, MPLS and GMPLS).

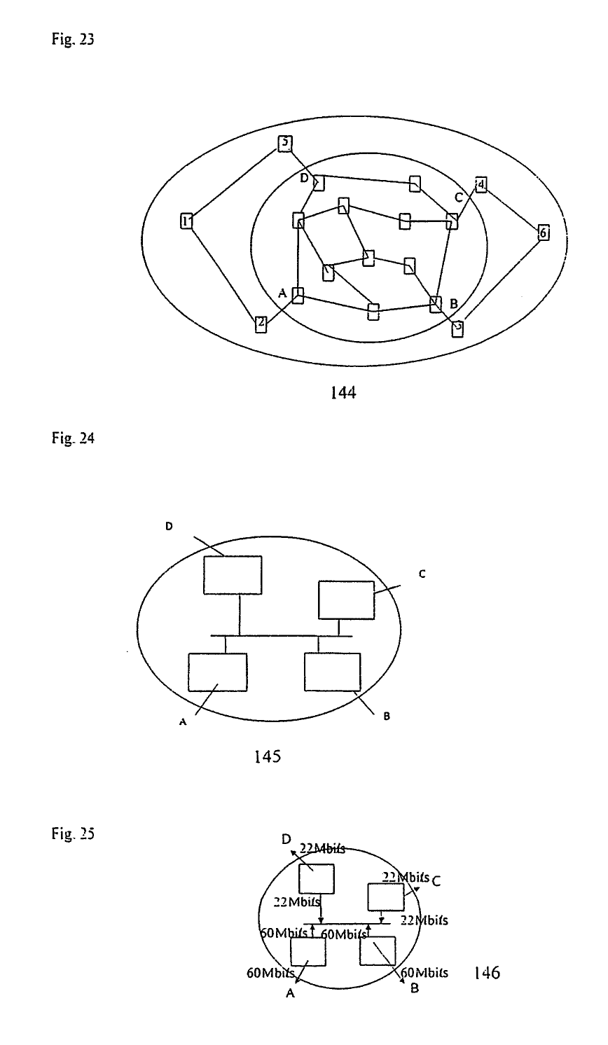

An important and unsolved question in connection with the IP/MPLS routers is, towards the IP/MPLS routers and thereby in their distributed network topology database, how to represent an OTN as a more simple VN topology which partly hides the inner topology of the OTN and partly conserves the same external connection points, and which in the best way conserves possible available bandwidth between these external connection points in through the OTN. FIG. 23 shows an example of this issue, in which the physical IP/MPLS router network is connected through the physical OTN. IP—The basic electronic network protocol being among other things used in the Internet to transport data packages.

A way of representing an OTN towards the surroundings with a VN exists, where there are as many nodes in the VN as there are external connection points in the OTN, and where all these nodes in the VN are mutually connected in pairs in a fully meshed topology. However, this scales poorly when the number of connection points grows.

In accordance with the invention, a hiding of the inner topology of the OTN is carried out in an OTN of an arbitrary topology with the below-described simple VN topology (vide FIG. 24): A VN consisting of as many nodes as there are external connection points in the OTN that it represents. These nodes are connected together in a VN of a single shared link (in OSPF and ISIS terminology called a shared medium), and every node in the VN has an external connection point to the surroundings.

In order for the VN to be represented to the IP/MPLS routers, an available transmit bandwidth out of the link must be calculated in accordance with the IP/MPLS routing protocols (e.g. OSPF-TE and ISIS-TE) per link in the VN.

The algorithm employed is as follows:

It is supposed that the OTN towards the surroundings makes a function (hereafter called FN(x,y)) available, which function dynamically gives information on the size of a further connection (measured in bandwidth, VC12, VC3, VC4, wavelengths or the like) which could possibly be created between two arbitrary external connection points (x and Y) of the OTN. The algorithm utilizes the fact that FN(x,y) will return the same as FN(y,x) to a given later moment, because the OTN connections are bidirectional. Furthermore, the algorithm utilizes that for the OTN to a given time it applies that FN(x,y) will always be larger than or equal to the minimum of FN(x,z) and FN(z,y).

By means of the above-mentioned function FN(x,y), the algorithm hereafter firstly carries out a finding of the two external connection points, which in the OTN at the given time enables the largest connection bandwidth possible. Let us name these two found connection points z1, z2.

In the VN, the above mentioned two connection points z1, z2 are represented out toward the surroundings with the found (largest) bandwidth. Simultaneously, the link is represented from the belonging two nodes in the VN toward the shared link with the found bandwidth.

Hereafter, one of these two connection points is arbitrarily used in the algorithm, e.g. z1, and with this as a starting point, the bandwidth to each of the rest of the connection points is calculated in turn by means of the OTN FN(z1,y) function.

The found bandwidth is used at the belonging connection point in the VN against the surroundings as well as on the accompanying link toward the shared link in the same node.

Hereafter, it is finally checked in the algorithm, on each of the external connection points toward the directly attached IP/MPLS routers, if the calculated bandwidth is smaller than the physically available amount toward the attached IP/MPLS router. The minimum of these two bandwidth values is then selected as the available bandwidth in the external connection point.

Hereafter, the selected VN, including available link bandwidths, is notified out into the IP/MPLS router network as representative for the OTN and thereby ends in the distributed topology database which is present in the IP/MPLS routers.

### EXAMPLE

Suppose that an OTN can be represented by a VN with 4 external connection points called A, B, C and D. Suppose that the function FN(x,y) returns the following available bandwidth between the two external connection points:

| | B | C | D |
|---|---|---|---|
| A | 60 Mbit/s | 22 Mbit/s | 22 Mbit/s |
| B | | 22 Mbit/s | 22 Mbit/s |
| C | | | 30 Mbit/s |

As the calculation algorithm describes, the OTN path that has the potentiality of the highest bandwidth, i.e. A-B having 60 Mbit/s, is firstly selected. This is why the external connection points, called A and B, are each given 60 Mbit/s in the example below on the VN. Furthermore, the bandwidth in toward the shared link from the node with A and B are also each given 60 Mbit/s.

According to the calculation algorithm, the next step is to use A as a basis and calculate the available bandwidth to each additional external connection point with the F(A,y) function. The available bandwidth from A to C in the OTN, i.e. 22 Mbit/s is used as the bandwidth which is to be represented on the basis of C in FIG. 25. Furthermore, 22 Mbit/s are given in toward the shared link in the node with C. Hereafter, the bandwidth value from A to D in the OTN can be observed and is filled out the same way as D and C, in this case also 22 Mbit/s.

Hereafter, the four selected external bandwidths are checked separately in order to state if they exceed what is physically available out toward every directly attached IP/MPLS router, (e.g. from A out to directly attached IP/MPLS router(s) etc.)—and the minimum is then selected as the bandwidth on the connection point.

Hereafter, the selected VN is announced, including the available link bandwidths out into the IP/MPLS router network as a representative for the OTN, and thereby ends in the distributed topology database which is present in the IP/MPLS routers.

The system according to the invention comprises the following elements:
Queue system giving the possibility of having a FIFO queue per data flow or traffic class.
Control unit for the distribution of traffic between numerous distribution and priority units.
Delay unit for the timely distribution of data packages (“shaping”; defined as an electronic transmission mechanism ensuring that, as an average, the transmissions take place at a specifically indicated speed).
Priority unit enabling a possibility of putting data flows in order of priority.
   By implementing digital communication systems, a central buffer system is typically used for the storage of the data packages, hereby operating with pointers for packages instead of using the packages themselves in the queue system, etc. It is only in connection with the transmission that the data packages will be read from the central buffer system. When the data packages will be mentioned in the following description it might as well be pointers for data packages which are being described, or alternatively pointers for queues in the queue system, in which these pointers are hidden.

Data cells or packages which are received by the switch system will, after a possible switching or routing (which is not part of this description), be input to one or more queues in the queue system. Each queue in the system represents different data flows that are desired to be mutually regulated. It can be either individual data flows or traffic classes. In the following only one system is treated with a single transmission channel.

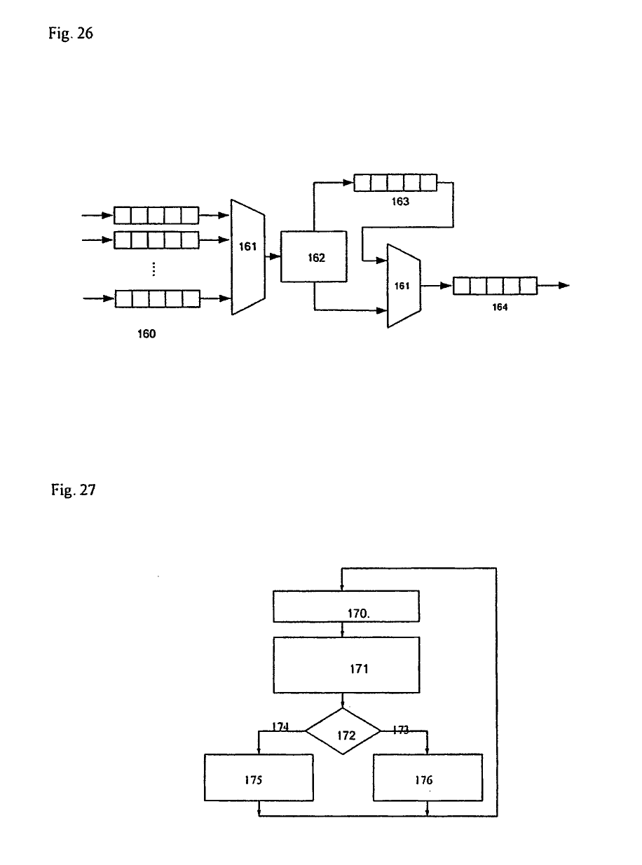

Referring to FIG. 26, traffic is output from a queue system 160 through a first multiplexer 161. This first multiplexer 161 will typically be part of the queue system 160, and will thus not exist as an independent logic unit. After the output of a data package from the queue system 160, the package will be input into a control unit 162 and then into a second multiplexer 165, either directly or through a delay unit 163. From the second multiplexer 165, the data package is sent to a priority unit 164.

As time goes by and capacity becomes available on the data channel, data packages will be output and transmitted from the priority unit 164. The priority unit 164 operates with virtual time, the result being thus that a data package will always be output unless the priority unit 164 is completely empty.

Data packages from the delay unit 163 will not be transmitted immediately, but will instead be transmitted to the priority unit 164 through the second multiplexer 165 as data packages become ready for output. As the delay unit 163 operates with absolute time, several data packages can be ready for output at the same time. It is possible to make a less resource-demanding implementation where it is only possible to output at a limited speed.

The delay unit 163 and the priority unit 164 will together consist of one single data package as a maximum from each queue in the queue system 160. Every time a package is output from the priority unit 164, a new package belonging to the same queue in the queue system 160 will be read and transmitted to either the delay unit 163 or the priority unit 164, unless this queue is empty.

If a package arrives to a queue in the queue system 160 for which no data package exists in the delay unit 163 or the priority unit 164, the data package will be directly transmitted to the delay unit 163 or the priority unit 164.

For distributing the data packages, which are output from the queue system between the delay unit 163 and the priority unit 164, the control unit 162 is used. The control unit 162 also determines the delay, which is used at the input in the delay unit 163. The control unit 162 will typically comprise a Leaky Bucket algorithm for each queue in the queue system 160.

Continuous-state Leaky Bucket has to state variable bucket-level and time-stamp which are updated each time a data package is output from the queue system. In FIG. 27 is shown a flow diagram for this algorithm.

Data packages which are input in the delay unit 163 are time stamped with the value
time+delay_time
where time indicates the time (in the form of a continuous counter) and delay_time indicates the wanted delay of time. Data packages are output again when the value of time exceeds the time stamp of the package. If an output can not take place at an arbitrarily high speed, the data package with the lowest time stamp is to be output first.

Data packages that are input in the priority unit 164 are time stamped with the value
virtual_time+1/w(i)
where virtual_time indicates a virtual time, and w(i) indicates the priority for the current data flow. Data packages are output at the speed at which they can be transmitted over the data channel, and the virtual_time is sequentially set to the time stamp for the last output data package.

If, instead of giving an order of priority at the package level, there is given an order of priority in relation to used bandwidth, thus regarding the length of each package, an implementation where the time stamp is set to
virtual_time+package_length/w(i)
can be used, where package_length indicates the length of the current package.

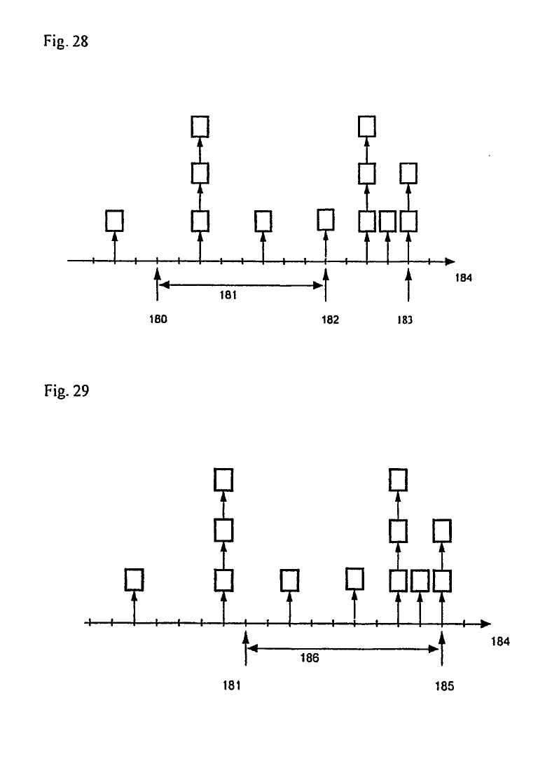

When implementing the delay unit 163 and the priority unit 164, a solution as shown in FIG. 28 and FIG. 29 will typically be used.

Characteristics of this Aspect of the Invention

System for scheduling data traffic, in which the data packages are distributed by a control unit between several scheduling units with different characteristics.

Unity for the distribution of data traffic between several scheduling units, in which one or more “leaky bucket” algorithms are used for the distribution of the data packages between the scheduling units.

System for the scheduling of data traffic where bucket_level from “leaky bucket” algorithms are used for the delay of data traffic prior to further treatment in the system.

System for the scheduling of data traffic, in which a delay unit is followed by one or more priority units.

Appendix A Definition List of Technical Abbreviations

This paragraph defines a number of technical concepts and terms which are used in the document.

| Word | Description |
|---|---|
| AAL5 | A package transport form in ATM. |
| The Access net | The part of the telecommunications infrastructure connecting the |
| | private companies and the users to the telecommunications |
| | infrastructure |
| ADSL | Asymmetric Digital Subscriber Line - A technology using the existing |
| | telephone lines out to the private homes. |
| ASIC | Application Specific Integrated Circuit - Integrated circuit developed |
| | for a specific purpose. |
| ANSI | Organisation standardising the American telecommunications |
| | protocols, among others the Sonet. |
| ATM | Asynchronous Transfer Mode. An electronic data protocol which is |
| | widespread in the Access net of the telecommunications |
| | infrastructure. |
| CMOS | ASIC technology for digital circuits. |
| DWDM | Dense Wavelength Division Multiplexing - A technology for sending |
| | via several frequencies (colours) in one fibre thereby increasing the |
| | entire capacity per fibre. |
| Edge Router | An IP Router which can convert to/from MPLS/GMPLS. |
| Ethernet | The most widespread electronic transport protocol which within the |
| | companies' local network is used to connect PC's, servers etc.. |
| FPGA | Field Programmable Fate Array. A hardware component which can |
| | be programmed contrary to an ASIC. Has lower performance and |
| | integration possibilities than an ASIC. |
| Frame Relay | An older electronic data protocol which is widespread within the |
| | Access net of the telecommunications structure. |
| GFP | Generic Framing Procedure. A new protocol for the mapping of |
| | packages within SDH/Sonet. |
| GMPLS | Generalised Multi Protocol Label Switching. A further development |
| | of MPLS so it also can be used in ADH/Sonet based networks. |
| IEEE | Organisation standardising the Ethernet protocols. |
| IETF | Organisation standardising the Internet protocols, among others IP, |
| | MPLS and GMPLS. |
| ITU | Organisation standardising telecommunications protocols, among |
| | others SDH. |
| IP | The basic electronic network protocol being among other things |
| | used in the Internet to transport data packages. |
| IPdiff.service | An expansion to the IP protocol so that several types of traffic with |
| | different time requirements (data, telephony, video) can be sent |
| | over the same line, i.e. where different priorities can be given to the |
| | individual packages. |
| LSR | Label Switch Router. A very quick package switch based on the |
| | MPLS/GMPLS protocol. |
| LAN | Local network. Typically used in a company to connect among |
| | others PC's and servers. |
| MPLS | Multi Protocol Label Switching. The next generation's protocol being |
| | a further development of the IP and which has the necessary |
| | scalings quality for the Internet in order to meet the new |
| | requirements on speed and minimum delays for new IP services - |
| | among others Internet telephony based on IP. |
| OC48 | Line interface in Sonet with a speed of 2.5 Gigabit/s in each |
| | direction. |
| OC192 | Line interface in Sonet with a speed of 10 Gigabit/s in each |
| | direction. |
| OSI management | The protocol which is most often used by the teleoperators in |
| | connection with the supervision of the telecommunications |
| | transmission equipment. |
| OSPF | Open Shortest Path First. One of the large software IP routing |
| | protocols which are used in IP routers to distribute knowledge about |
| | the topology in an IP network. |
| Policing | An electronic package receiving mechanism controlling that a given |
| | sender does not transmit more than agreed. |
| PPP | Point to Point Protocol. A protocol for the establishing of IP point to |
| | point connections. |
| RSVP | Resource Reservation Protocol. A software protocol used in the IP |
| | routers to reserve bandwidth etc. |
| SDH | Synchronous Digital Hierarchy. the underlying electronic transport |
| | protocol which is used today in the European part of the |
| | telecommunications infrastructure. |
| Shaping | An electronic transmissions mechanism ensuring that as an |
| | average, the transmissions take place at a specifically indicated |
| | speed. |
| SNMP | Simple Network Management Protocol. The protocol which is most |
| | often used to supervise LAN equipment. |
| Sonet | Synchronous Optical Network. The underlying electronic transport |
| | protocol which is used today in the American part of the |
| | telecommunications infrastructure. |
| STM16 | Line interface in SDH with a speed of 2.5 Gigabit/s in each direction. |
| STM64 | Line interface in SDH at a speed of 10 Gigabit/s in each direction. |
| Terabit/s | 1000 Gigabit/s. |
| The transport part of | The basic telecommunications network connecting all cities and |
| the telecommunications | areas in the world and which is used to transport telephony and |
| infrastructure | data. |
| The trunk net | The backbone in the telecommunications network. The part of the |
| | telecommunications structure which connects territories, cities and |
| | countries. |
| VC3, VC4, VC4c | Different types of logic channels in SDH/Sonet. |
| VLAN | Virtual LAN. Defined in IEEE and used on the Ethernet to support |
| | several LAN's through the same cable. |
| VPN | Virtual Private Network. A company's virtual IP network through the |
| | public infrastructure. It is virtual because all the companies' VPN are |
| | based on the same public IP infrastructure without traffic being |
| | intermingled between the firms. |

Appendix B References in FIGS. 1-29

| Figure Text | Description |
|---|---|
| 1 | Central Management Centre |
| 2 | GMPLS Software |
| 3 | GMPLS software server |
| 4 | GMPLS topology and reservation packages sent or controlled by Central |
| | Management Centre |
| 5 | IP Router |
| 6 | SDH/SonetAdd/Drop Multiplexer or similar SDH/Sonet product |
| 7 | SDH/Sonet Net Work |
| 8 | GMPLS Channel through SDH/Sonet net work |
| 9 | User |
| 10 | Web Host |
| 11 | ADSL connection |
| 12 | Access part of SDH/Sonet net work |
| 13 | Backbone part of SDH/Sonet net work |
| 14 | DSLAM |
| 15 | Fibre based rings based on DWDM and SPH/Sonet |
| 16 | TCP or business |
| 17 | IP |
| 18 | AAL5, A package transport form in ATM |
| 19 | ATM |
| 20 | DWDM product |
| 21 | ATM switch |
| 22 | SDH/Sonet |
| 23 | ADSL |
| 30 | Connection between two IP routers through SDH/Sonet net work |
| 31 | Similar to 30, however having increased band width as compared to 30 |
| 40 | Package Forwarding in Hardware |
| 41 | Package Forward table or scheme |
| 42 | Router Software |
| 43 | OSPF topology data base |
| 44 | IP Packages |
| 95 | IP/MPLS Router |
| 96 | GMPLS enabled product of the type 6 or 20 |
| 100 | MPLS Package belonging to a dynamic MPLS tunnel |
| 101 | Connection between two IP/MPLS routers through SDH Sonet |
| 110 | Each individual byte from a package sent in specific timeslots, belonging to |
| | the dynamic GMPLS based SDH/Sonet tunnel |
| 120 | Tunnels being byte interleaved |
| 121 | Tunnels being package interleaved |
| 122 | Byte in dynamic GMPLS SDH/Sonet tunnel |
| 123 | MPLS/GMPLS converter |
| 130 | SDH/Sonet management software |
| 131 | GMPLS software including protocols |
| 140 | Example of an arbitrary net work (OTN) including 4 external connections |
| | through A, B, C and D |
| 141 | Two different examples of simple Virtual Net works (VN) hiding the |
| | topology of optical net work (OTN), however preserving the same external |
| | connection through A, B, C and D |
| 142 | Example of a distributed data base, shown visual representing an IP/MPLS |
| | net work having 5 IP/MPLS routers and exhibiting free band width per link |
| | between IP/MPLS routers |
| 143 | Example similar to 142 after signalling of a connection of 2 Mbit/s between |
| | routers 1 and 5. |
| 144 | Example of a physical IP/MPLS net work comprising 6 IP/MPLS routers, |
| | the routers 2, 3, 4 and 5 in this example being connected through an inner |
| | complex optical net work (OTN)-connected through A, B, C and D |
| 145 | Example of a Virtual net work (VN) representing an optical net work (OTN) |
| | having 4 external connections A, B, C and D |
| 146 | Mapping of free band width |
| 160 | Queuing system |
| 161 | First Mux (165 = Second Mux) |
| 162 | Control unit |
| 163 | Delay unit |
| 164 | Priority unit |
| 170 | Reading of data package from queuing system |
| 171 | dt = time − time_stamp |
| | drain = decrement * dt |
| | bucket_drain = max(0, bucket_level − drain) |
| | bucket_level = bucket_drain + increment * package_length |
| 172 | bucket_level > limit ? |
| 173 | No |
| 174 | Yes |
| 175 | Read data package for delay unit |
| | delay = (bucket_level − limit)/ decrement |
| 176 | Read data package for priority unit |
| 180 | Delay |
| 181 | Write index |
| 182 | Current time |
| 183 | Read index |
| 184 | Time |
| 185 | Virtual time |
| 186 | Packet_length/w(i) |

1-4. (canceled)

5. A telecommunications network comprising:
a SDH/Sonet sub-network having a transport network; and
a GMPLS software server in which is collected a GMPLS function for the SDH/Sonet sub-network.

6. The network according to claim 5, characterized in that, in an external limit of the SDH/Sonet sub-network, units are provided for collecting GMPLS reservation packages, wherein the units communicate with the network outside the SDH/Sonet sub-network on behalf of the SDH/Sonet sub-network

7. The network according to claim 6, wherein the units comprise MPLS/GMPLS enabler cards.

8. The network according to claim 5, wherein the GMPLS software server network makes GMPLS tunnels into the SDH/Sonet sub-network, wherein the tunnels are available for an external IP/MPLS network.
